(19) United States
(12) Patent Application Publication
(10) Pub. No.: US 2019/0044591 A1
(43) Pub. Date: Feb. 7, 2019

(54) BASE STATION, USER EQUIPMENT, PRECODING MATRIX APPLICATION METHOD, AND PRECODING MATRIX ACQUISITION METHOD

(71) Applicant: NTT DOCOMO, INC., Tokyo (JP)

(72) Inventors: Yousuke Sano, Tokyo (JP); Kazuaki Takeda, Tokyo (JP); Satoshi Nagata, Tokyo (JP); Chunlin Yan, Beijing (CN); Anxin Li, Beijing (CN); Huiling Jiang, Beijing (CN)

(73) Assignee: NTT DOCOMO, INC., Tokyo (JP)

(21) Appl. No.: 16/073,979

(22) PCT Filed: Feb. 1, 2017
(86) PCT No.: PCT/JP2017/003597

§ 371 Date: Jul. 30, 2018

(30) Foreign Application Priority Data
Feb. 4, 2016 (JP) 2016-020330

(51) Int. Cl. H04B 7/0456

(52) U.S. Cl. CPC H04B 7/0456; H04J 15/00

(57) ABSTRACT

A base station used in a radio communication system includes a precoding matrix calculating unit that calculates a precoding matrix based on a first precoding matrix reported from a first user equipment in a pair selected as a target of multiplexing in a power region and a second precoding matrix reported from a second user equipment in the pair and a precoding unit that applies a precoding to transmission signals to the first user equipment and the second user equipment using the precoding matrix calculated by the precoding matrix calculating unit.

### TECHNICAL FIELD

The present invention relates to a radio communication system to which Non-Orthogonal Multiple Access (NOMA) is applied.

### BACKGROUND ART

Non-Orthogonal Multiple Access (NOMA) is under review in 5G which is a next generation mobile communication system. NOMA is a multiple access technique of multiplexing signals addressed to a plurality of user equipments UEs (hereinafter, referred to as “UEs”) in a cell onto the same resources at a base station eNB (hereinafter, “eNB”) side and simultaneously transmitting the signals. As a result, further improvement in frequency use efficiency is expected.

A basic principle of a downlink of NOMA will be described with reference to FIGS. 1 and 2A-C (for example, Non-Patent Document 1). A UE 1 close to an eNB and a UE 2 near a cell edge are illustrated in FIG. 1.

The eNB selects the UE 1 and the UE 2 as a pair, multiplexes a signal of the UE 1 and a signal of the UE 2 using the same resource and simultaneously transmits the signals as illustrated in FIG. 2A. At this time, high power is allocated to the UE 1 at the cell edge, and low power is allocated to the UE 2 near the cell center.

A signal addressed to the UE 1 and a signal addressed to the UE 2 arrive at the UE 2 near the cell center in a multiplexed form, but as illustrated in FIG. 2B, the signal of the UE 2 can be decoded by removing the signal of the UE 1 through an interference cancellation process. On the other hand, for the UE 1 at the cell edge, since low power is allocated to the signal of the UE 2 serving as interference to the UE 1, the signal of the UE 2 becomes very weak as illustrated in FIG. 2C. Therefore, the UE 1 can directly decode the signal addressed to the UE 1 without performing the interference cancellation process. As described above, in NOMA, multiplexing in the power region is performed, but the technique of performing multiplexing in the power region is not limited to NOMA.

Further, MIMO introduced into an LTE system can be combined with NOMA, and in this case, it is possible to further improve system performance. In downlink MIMO specified in LTE, in order to improve a reception SINR, precoding (an adjustment of a phase and an amplitude) is used, and a precoded signal is applied to each antenna.

### CITATION LIST

### Non-Patent Document

Non-Patent Document 1: NTT DOCOMO Technical Journal VOl. 23 No. 4
Non-Patent Document 2: R1-153333
Non-Patent Document 3: R1-154657
Non-Patent Document 4: R1-153332

### SUMMARY OF THE INVENTION

### Problem to be Solved by the Invention

In NOMA to which MIMO is applied, any kind of precoding matrix may be selected and transmitted for a pair of UEs that perform multiplexing. In other words, the UE 1 and the UE 2 may use the same precoding matrix or different precoding matrices. However, for example, when the UE 2 near the cell center cancels interference of the UE 1 using an algorithm such as maximum likelihood determination detection, interference cancellation performance can be significantly improved if the same precoding matrix is used. It is because a scheme in which signals of a pair of UEs are combined and arranged on a constellation and then undergo the precoding is assumed in the eNB (Non-Patent Document 2). Therefore, when NOMA in which the UE performs interference cancellation using an algorithm such as the maximum likelihood determination detection is assumed, a constraint that the precoding matrices of the UEs to be multiplexed should be the same is considered.

However, due to this constraint, a possibility that each UE will be a pairing target decreases. This leads to a problem in that the performance of NOMA may deteriorate. Non-Patent Document 3 discloses a technique of improving probability of UE pairing such that the UE reports a best PMI and a second best PMI to the eNB, and the eNB also allows the use of the second best PMI. However, in this method, a feedback amount from the UE increases, and performance improvement is limited as well.

The present invention was made in light of the foregoing, and it is an object of the present invention to provide a technique capable of increasing a possibility that each user equipment will be a pairing target without increasing the feedback amount from the user equipment in the technique in which multiplexing in a power region is performed.

### Means for Solving Problem

According to the present invention, provided is a base station used in a radio communication system, including:

a precoding matrix calculating unit that calculates a precoding matrix based on a first precoding matrix reported from a first user equipment in a pair selected as a target of multiplexing in a power region and a second precoding matrix reported from a second user equipment in the pair; and

a precoding unit that applies a precoding to transmission signals to the first user equipment and the second user equipment using the precoding matrix calculated by the precoding matrix calculating unit.

Further, according to the present invention's embodiment, provided is a user equipment used in a radio communication system, including:

a transmitting unit that transmits an index of a first precoding matrix to a base station; and

a receiving unit that receives a precoding matrix calculated in the base station or an index of the precoding matrix from the base station,

wherein the user equipment is a first user equipment in a pair selected as a target of multiplexing in a power region by the base station, and

the precoding matrix is a precoding matrix calculated by the base station based on the first precoding matrix and a second precoding matrix of a second user equipment in the pair.

Further, according to the present invention's embodiment, provided is a user equipment that is used in a radio communication system and serves as a first user equipment in a pair selected as a target of multiplexing in a power region by a base station, including:

a transmitting unit that transmits an index of a first precoding matrix to the base station;

a receiving unit that receives a second precoding matrix of a second user equipment in the pair from the base station; and

a precoding matrix calculating unit that calculates a precoding matrix to be applied to the user equipment in the base station based on the first precoding matrix and the second precoding matrix.

According to the embodiment of the present invention, a precoding matrix application method performed by a base station and a precoding matrix acquisition method performed by a user equipment are provided.

### Effect of the Invention

A technique capable of increasing a possibility that each user equipment will be a pairing target without increasing the feedback amount from the user equipment in the technique in which multiplexing in a power region is performed is provided.

### BRIEF DESCRIPTION OF DRAWINGS

FIG. 1 is a diagram for describing a basic principle of NOMA;

FIG. 2A is a diagram for describing a basic principle of NOMA;

FIG. 2B is a diagram for describing a basic principle of NOMA;

FIG. 2C is a diagram for describing a basic principle of NOMA;

FIG. 3 is a configuration diagram of a radio communication system according to an embodiment of the present invention;

FIG. 4 is a sequence diagram illustrating a flow of a basic process according to the present embodiment;

FIG. 5 is a diagram illustrating a vector image of weighted addition;

FIG. 6 is a diagram for describing a procedure of deciding a parameter β;

FIG. 7 is a diagram illustrating a sequence example related to a parameter notification to a UE;

FIG. 8 is a configuration diagram of a user equipment UE;

FIG. 9 is a HW configuration diagram of a user equipment UE;

FIG. 10 is a configuration diagram of a base station eNB; and

FIG. 11 is a HW configuration diagram of a base station eNB.

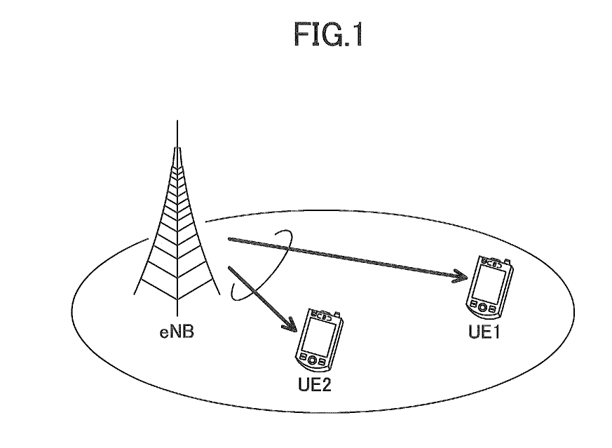

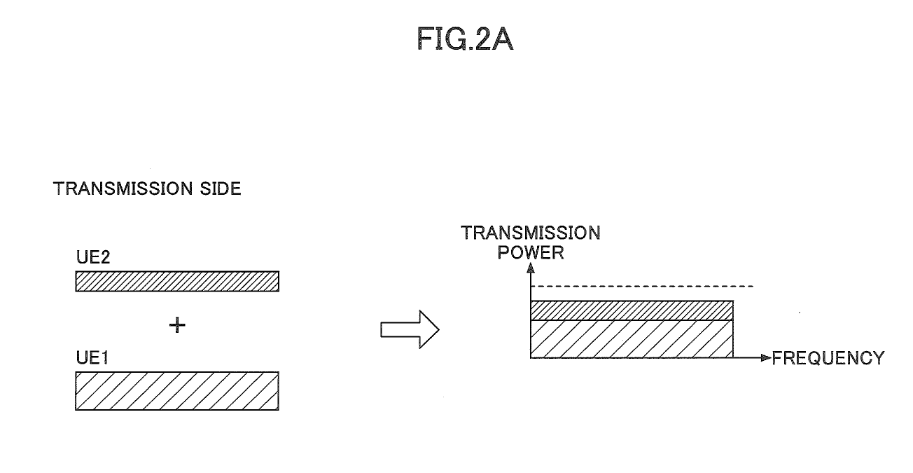

### MODE(S) FOR CARRYING OUT THE INVENTION

Hereinafter, an exemplary embodiment of the present invention will be described with reference to the appended drawings. An embodiment to be described below is merely an example, and an embodiment to which the present invention is applied is not limited to the following embodiment. For example, a mobile communication system according to the present embodiment is assumed to be a system of a scheme conforming to LTE, but the present invention is not limited to LTE but is applicable to other schemes. Further, in this specification and claims, “LTE” is used in a broad sense including communication schemes (including 5G) corresponding to Rel-12, 13, 14, or later of 3GPP. Further, a “precoding matrix” to be described below is used as including a meaning of a “precoding vector.”

(System Configuration)

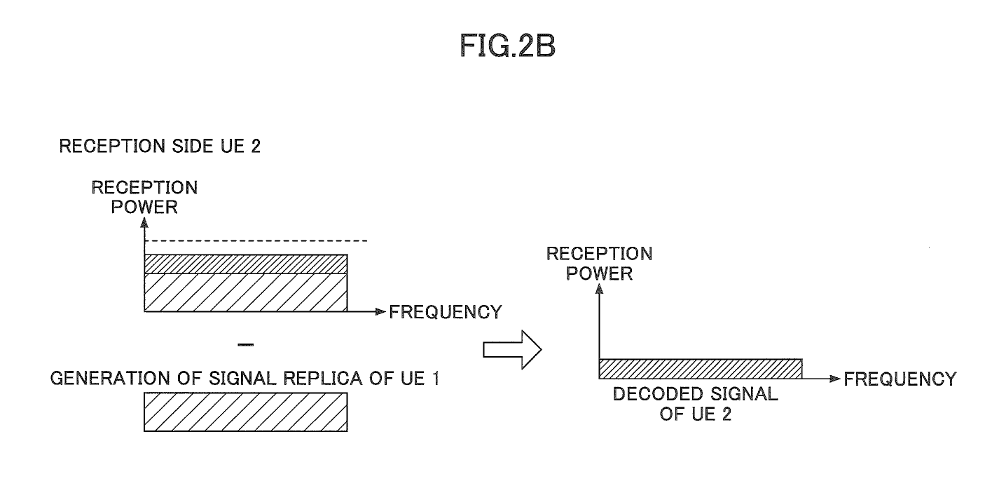

FIG. 3 is a configuration diagram of a radio communication system according to an embodiment of the present invention. As illustrated in FIG. 3, the radio communication system of the present embodiment includes a base station eNB (hereinafter, “eNB”), a user equipment UE 2 close to the eNB (hereinafter, “UE 2”), and a user equipment UE 1 at a cell edge (hereinafter, “UE 1”). The eNB and the UEs have at least functions of LTE and a function of performing NOMA to which MIMO is applied.

As described above, NOMA is a multiple access technique of multiplexing signals addressed to a plurality of UEs in a cell onto the same resources at the eNB side and transmitting the signals at the same time, and multiplexing of user signals in the power region is performed. The user signals multiplexed in the power region are separated by power distribution between paired users and application of the interference cancellation function in the UE. The technique of performing multiplexing in the power region is not limited to NOMA.

There are many UEs in the cell of the eNB, but FIG. 3 illustrates two UEs (the UE 1 and the UE 2) constituting a pair selected as a target of multiplexing in the power region among by the eNBs. In other words, FIG. 3 illustrates that the eNB receives channel quality information (CQI) from each UE, and the UE 1 and the UE 2 are selected as a result of pair selection based on the received CQI of each UE. The power ratio is also decided when a pair is selected. However, in the present embodiment, it is unnecessary to pair UEs that have reported the same PMI, and it is possible to increase the number of UE pairings. In other words, there is a high possibility that each UE will be paired with other UEs.

In the eNB to which NOMA is applied, for example, scheduling for selecting a pair of UEs is performed as follows (Non-Patent Document 4).

First, one power set is selected from a set of predetermined power sets (for example, (0.05, 0.95), (0.1, 0.9), . . . ), and a pair of UEs is selected for the selected power set. Then, an SINR for scheduling of each UE is calculated using the power set and the CQI reported from each UE, a throughput (an instantaneous throughput or an average throughput) of each UE is calculated from the SINR, and a proportional fairness (PF) metric of a pair of UEs is calculated. Such a PF metric is calculated for each power set and for each UE pair, and a pair of UEs and the power set in which the PF metric is maximum are decided.

In the present embodiment, the precoding matrix to be applied to a pair of UEs is calculated by performing weighted-addition (weighted-averaging) on precoding matrices selected as the best one by the UEs constituting the pair. A detailed description will be made below with reference to a sequence diagram and the like.

(Process Sequence)

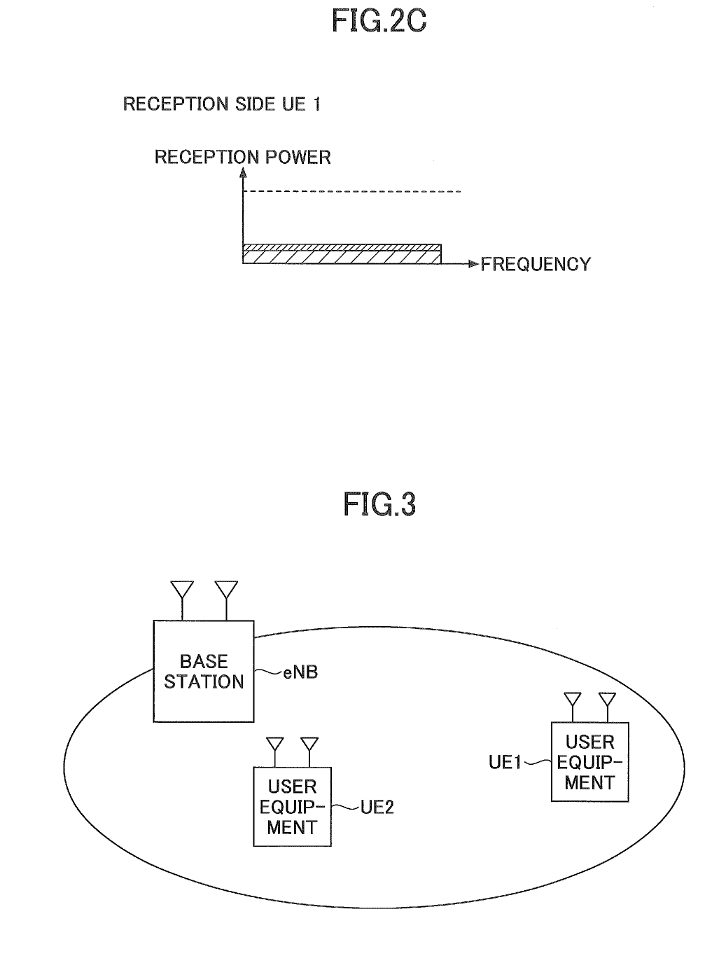

FIG. 4 is a sequence diagram illustrating a flow of a basic process according to the present embodiment. In step S101, the UE 2 transmits a CQI₂ and a PMI₂ calculated based on a channel state to the eNB as a CSI report. In step S102, the UE 1 transmits a CQI₁ and a PMI₁ to the eNB. The PMIs have been selected as the best PMI in the respective UEs.

Each UE calculates an SINR using, for example, a channel estimation value, a reception weight for demodulation, or the like for each applicable RI and each applicable PMI, and reports an RI and a PMI in which a data rate estimated from the SINR is maximum to the eNB. Further, a CQI corresponding to the SINR calculated from the RI and the PMI is reported to the eNB. The PMI calculated as described above is referred to as a best PMI.

Then, the eNB calculates a precoding matrix to be applied to a pair of UE 1 and UE 2 by weighted-adding (weighted-averaging) the precoding matrix corresponding to the PMI₁ of the UE 1 and the precoding matrix corresponding to the PMI₂ of the UE 2 (step S103). Here, if a weight coefficient is indicated by β, the precoding matrix of the UE 1 is indicated by W₁, and the precoding matrix of the UE 2 is indicated by W₂, the eNB calculates the precoding matrix W to be applied to a pair of UEs as described below. An example of the decision method of the parameter β will be described later.

[Math. 1]

W=\sqrt{β}W₁+\sqrt{1−β}W₂ Formula 1

Then, the eNB applies W and performs data transmission to the UE 2 and the UE 1 according to MIMO+NOMA (steps S104 and S105).

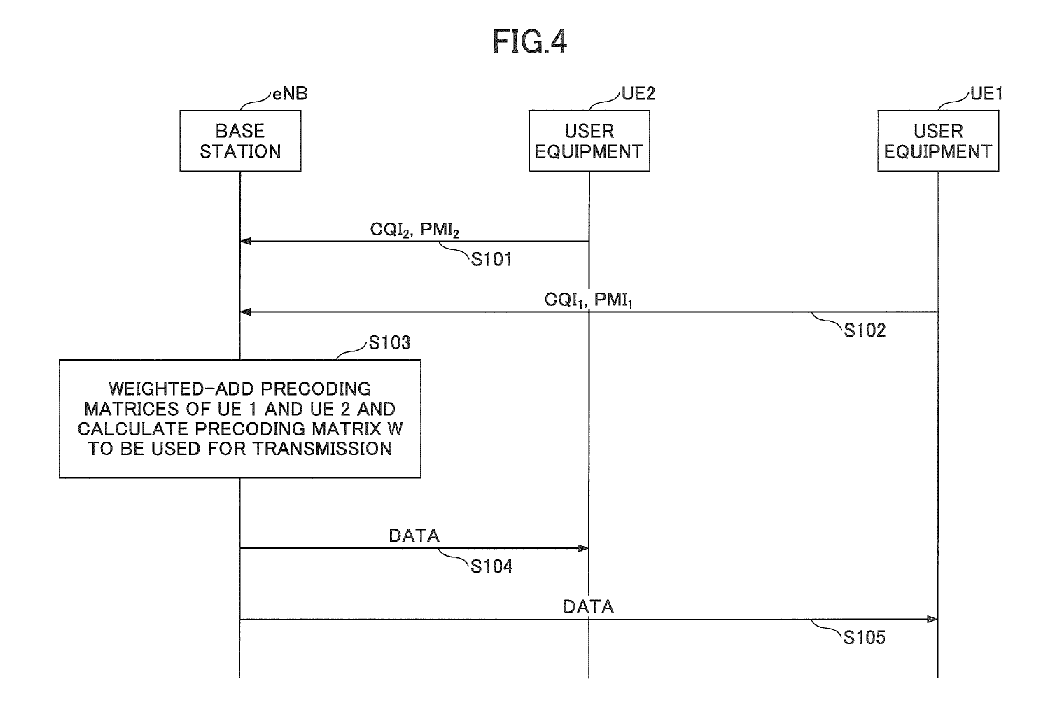

FIG. 5 is a diagram illustrating a vector image when W is obtained by weighted-adding W₁ and W₂ in Formula 1. As illustrated in FIG. 5, W is between W₁ and W₂, and it is possible to improve a geometric mean throughput of a pair of UEs using W.

In other words, according to the technique of the present embodiment, it is possible to increase a possibility that each user equipment will be a pairing target without increasing the feedback amount and improving throughput.

In the present embodiment, W is calculated by weighting and adding W₁ and W₂, but W may be calculated based on W₁ and W₂ by a method other than weighting and adding.

(Decision Method of Parameter β)

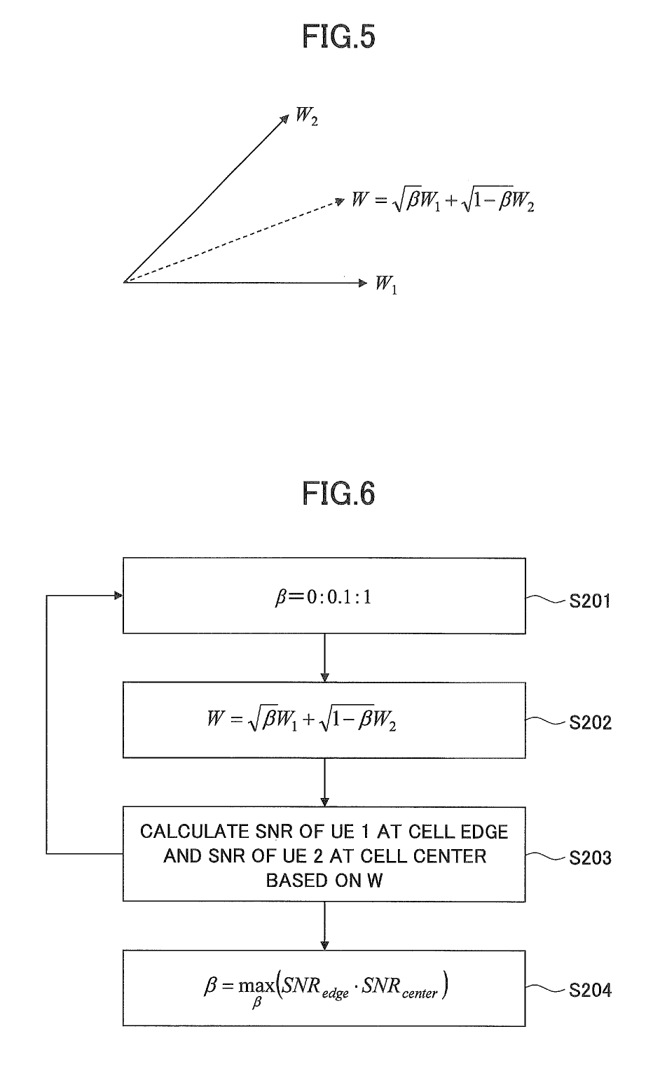

Next, an example of the decision method of the parameter β by the eNB will be described with reference to FIG. 6. The eNB performs a process of steps S202 and S203 while increasing β by 0.1 such as 0.1, 0.2, and the like. Specifically, the process is performed as follows.

First, using β selected in step S201, W is calculated from W₁ and W₂ using Formula 1 (step S202). Then, the eNB calculates an SNR of the UE 1 at the cell edge and an SNR of the UE 2 at the cell center based on W. Here, an SINR may be assumed to be calculated. The SNR and the SINR are referred to collectively as a “reception quality.”

When the calculations of the SNR of the UE 1 and the SNR of the UE 2 are completed for each β, in step S204, the eNB sets β in which a product of the SNR of the UE 1 and the SNR of the UE 2 is maximum as β of a target.

The above calculation of β is an example. β may be calculated by any other method.

(Signaling of W)

For example, when open loop control such as transmission mode 3 (TM3) is performed, the UE does not report the PMI to the eNB, and it is not necessary to notify each of a pair of UEs of W calculated as described above. However, even in the case of TM3, a notification of the PMI report or W may be given. On the other hand, when closed loop control like TM4 is performed, the eNB notifies each of a pair of UEs of W. An example of a method of notifying of W (options 1 to 3) will be described.

<Option 1>

In an option 1, the eNB notifies the UE 1 of β and the PMI₂ of the UE 2, and notifies the UE 2 of β and the PMI₁ of the UE 1. The UE 1 calculates W according to Formula 1 using W₁ corresponding to the PMI₁ of the UE 1, W₂ corresponding to the PMI 2, and β. Further, the UE 2 calculates W according to Formula 1 using W₂ corresponding to the PMI₂ of the UE 2, W₁ corresponding to the PMI₁, and β.

<Option 2>

In an option 2, the eNB transmits W to the UE 1 and the UE 2. Here, the calculated W may be transmitted, or a quantized W may be transmitted so as to reduce an amount of transmission information. The quantization means that a value (which is closest to an original element) selected from a plurality of predetermined values is used as a value of each element of W.

<Option 3>

In an option 3, the eNB quantizes W into one of precoding matrices included in a code book, and transmits an index (PMI) of the quantized W in the code book to the UE 1 and the UE 2. The code book assumed in each UE may be designated for all UEs or designated to each UE in a UE specific manner from the eNB.

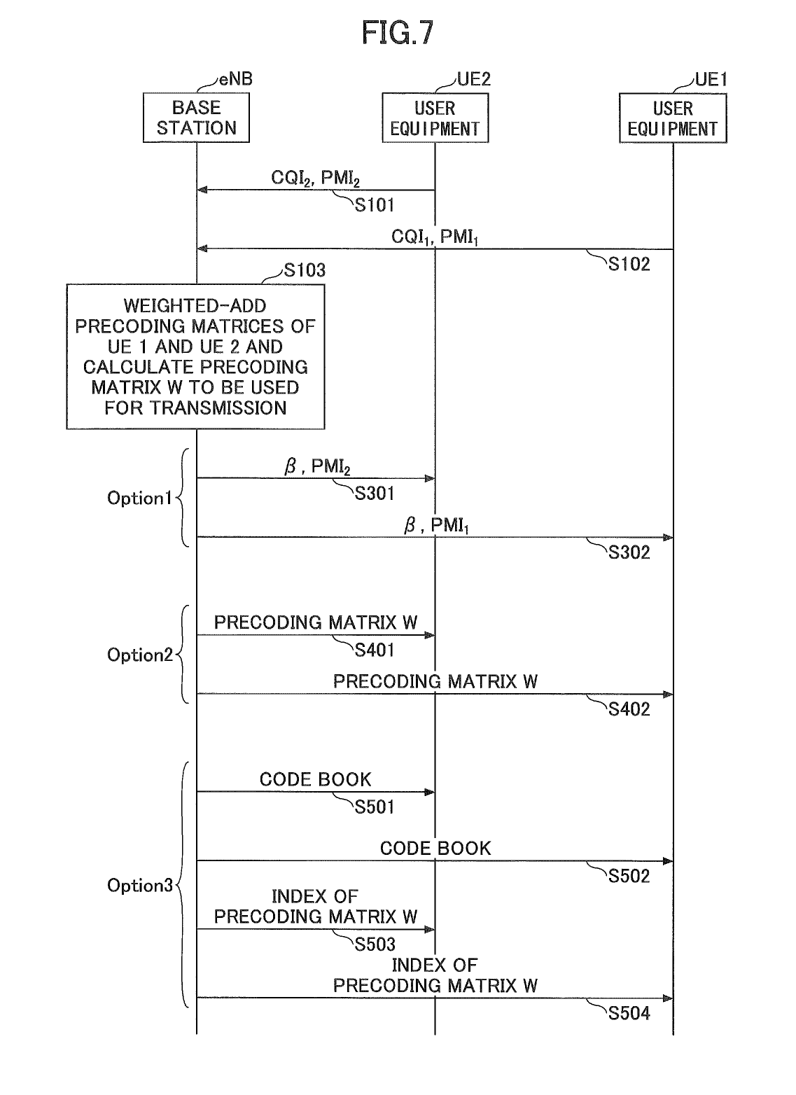

A sequence will be described with reference to FIG. 7. Steps S101 to S103 in FIG. 7 are identical to steps S101 to S103 in FIG. 4.

Steps S301 and S302 correspond to the option 1. In other words, the eNB notifies the UE 1 of β and the PMI₂ of the UE 2, and notifies the UE 2 of β and the PMI₂ of the UE 1. Further, in the option 1, for example, when β is decided in advance or when β is retained in each UE in advance, a notification of β may not be performed in steps S301 and S302.

Steps S401 and S402 correspond to the option 2. In other words, the eNB transmits W to the UE 1 and the UE 2. Steps S501, S502, S503, and S504 correspond to the option 3 in which the code book is transmitted in advance. In other words, the eNB transmits a codebook to the UE 1 and the UE 2 respectively, and further transmits the index of W. In FIG. 7, the transmission of the code book is performed after steps S101 to S103, but this is an example, and a transmission timing of the code book may be any timing before steps S503 and S504.

(Device Configuration)

Next, exemplary configurations of the UE and the eNB according to an embodiment of the present invention will be described.

<User Equipment UE>

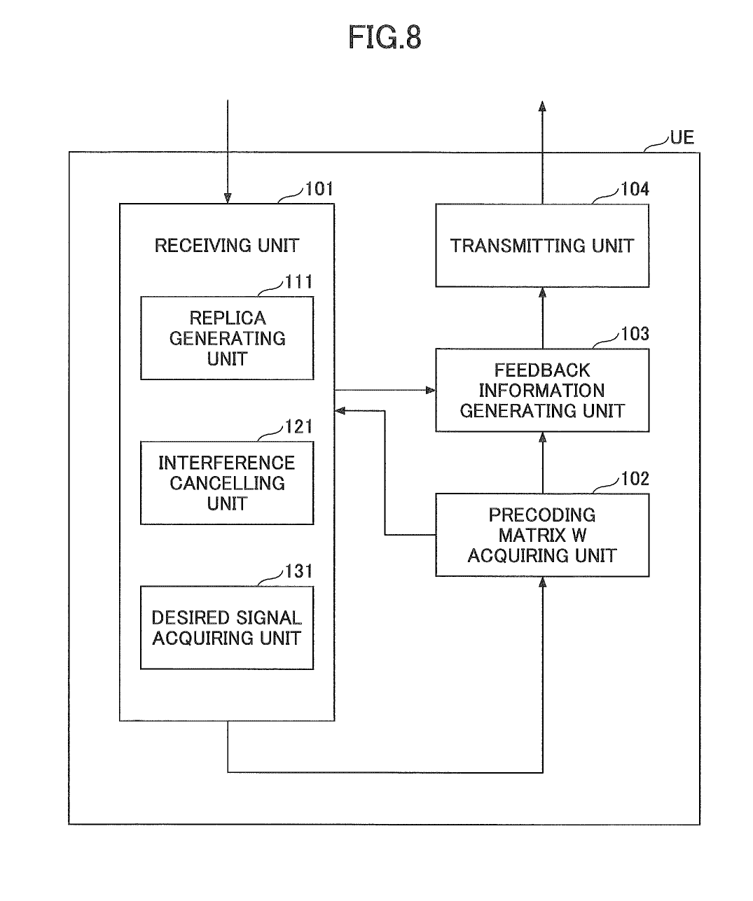

FIG. 8 illustrates a functional configuration diagram of the UE. FIG. 8 corresponds to a configuration of the UE 2 close to the eNB. Further, the example illustrated in FIG. 8 is an example in which signal (interference) cancellation of the other UE constituting a pair is performed using successive interference cancellation (SIC). Signal (interference) cancellation can be performed by any other method than the SIC.

As illustrated in FIG. 8, the UE includes a receiving unit 101, a precoding matrix W acquiring unit 102, a feedback information generating unit 103, and a transmitting unit 104. The receiving unit 101 includes a replica generating unit 111, an interference cancelling unit 121, and a desired signal acquiring unit 131. FIG. 8 illustrates only functional units of the UE particularly related to the present invention, and functions (not illustrated) for performing at least operations conforming to LTE are also provided.

The receiving unit 101 includes a function of receiving various downlink signals from the eNB and acquiring information of a higher layer from a received signal of a physical layer. In the receiving unit 101, first, a signal having strong reception power addressed to the UE 1 is decoded, and the replica generating unit 111 generates a replica of the signal of the UE 1 from the signal. The interference cancelling unit 121 separates the signal addressed to the UE 2 by subtracting the replica from the reception signal. Then, the desired signal acquiring unit 131 decodes a desired signal.

The precoding matrix W acquiring unit 102 acquires W based on information of which the eNB notifies. In the closed loop control, W is used for channel estimation in the receiving unit 101 and generation of feedback information in the feedback information generating unit 103.

In the case of the option 1, the precoding matrix W acquiring unit 102 calculates W from β, the PMI₁, and the PMI₂ using Formula 1. In the option 2, W received from eNB is used. In the option 3, W corresponding to an index received from the eNB is acquired from a code book (which is stored in a memory or the like of the UE).

The feedback information generating unit 103 calculates the RI, the PMI, the CQI, and the like to be reported to the eNB as the CSI report, and transmits the RI, the PMI, the CQI, and the like through the transmitting unit 104. The transmitting unit 104 has a function of generating various kinds of signals of the physical layer from information of the higher layer to be transmitted from the UE and transmitting the signals to the eNB.

The entire configuration of the UE illustrated in FIG. 8 may be implemented entirely by a hardware circuit (for example, one or more IC chips), or a part of the configuration of the UE may be implemented by a hardware circuit, and the other parts may be implemented by a CPU and a program.

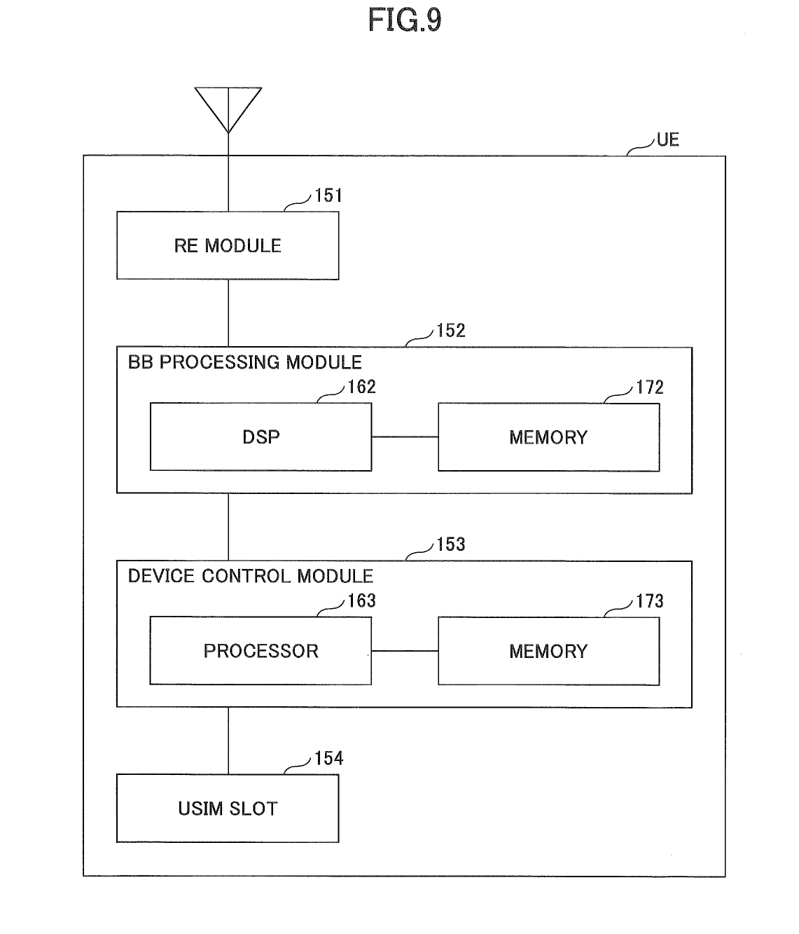

FIG. 9 is a diagram illustrating an example of a hardware (HW) configuration of the UE. FIG. 9 illustrates a configuration that is closer to an implementation example than FIG. 8. As illustrated in FIG. 9, the UE includes a radio equipment (RE) module 151 that performs processing relating to radio signals, a baseband (BB) processing module 152 that performs baseband signal processing, a device control module 153 that performs processing of a higher layer or the like, and a USIM slot 154 which is an interface for accessing a USIM card.

The RE module 151 performs digital-to-analog (D/A) conversion, modulation, frequency transform, power amplification, and the like on digital baseband signals received from the BB processing module 152 and generates radio signals to be transmitted from an antenna. Further, the RE module 151 performs frequency transform, analog to digital (A/D) conversion, demodulation, and the like on radio signals received from the antenna, generates digital baseband signals, and transfers the digital baseband signals to the BB processing module 152. For example, the RE module 151 includes functions of the physical layer or the like in the transmitting unit 104 and the receiving unit 101 of FIG. 8.

The BB processing module 152 performs a process of converting an IP packet into a digital baseband signal and vice versa. A digital signal processor (DSP) 162 is a processor that performs signal processing in the BB processing module 152. A memory 172 is used as a work area of the DSP 162. The BB processing module 152 includes, for example, a function of the layer 2 or the like in the transmitting unit 104 and the receiving unit 101, the function of the precoding matrix W acquiring unit 102, and the function of the feedback information acquiring unit 103 in FIG. 8. All or some of the functions of the precoding matrix W acquiring unit 102 and the functions of the feedback information acquiring unit 103 may be included in the device control module 153.

The device control module 153 performs protocol processing of the IP layer, processing of various kinds of applications, and the like. A processor 163 is a processor that performs processing performed by the device control module 153. A memory 173 is used as a work area of the processor 163. Further, the processor 163 performs reading and writing of data with a USIM via the USIM slot 154.

<Base Station eNB>

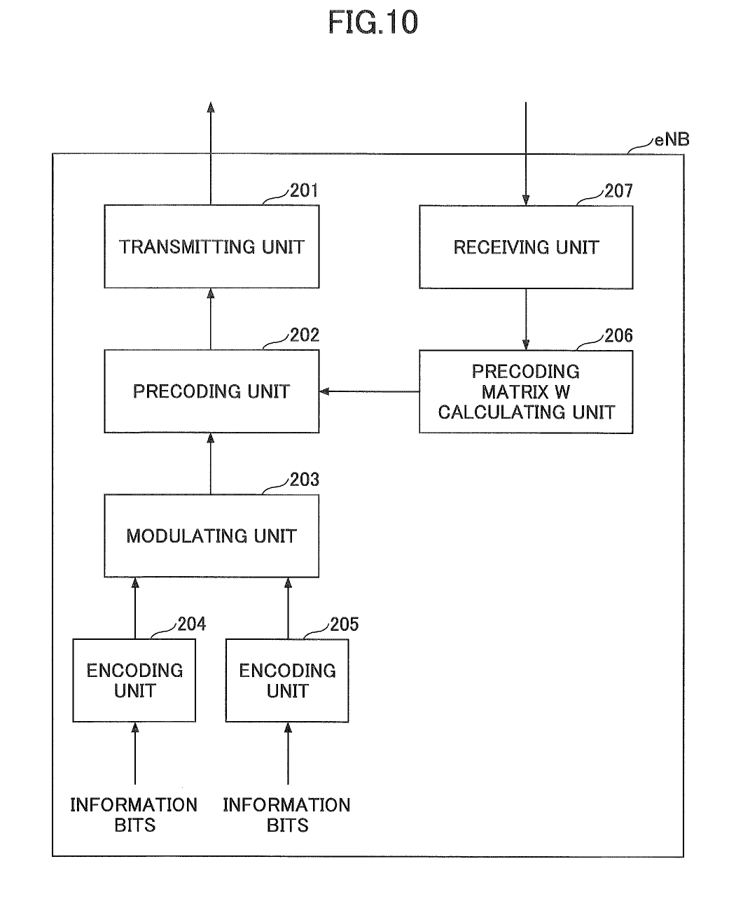

FIG. 10 illustrates a functional configuration diagram of the eNB. The configuration illustrated in FIG. 10 is a configuration related to an operation when a certain pair of UEs (for example, the UE 1 and the UE 2) is selected. As illustrated in FIG. 10, the eNB includes a transmitting unit 201, a precoding unit 202, a modulating unit 203, an encoding unit 204, 205, a precoding matrix W calculating unit 206, and a receiving unit 207. FIG. 10 illustrates only the functional units of the base station eNB particularly related to the embodiment of the present invention, and functions (not illustrated) of performing at least operations conforming to LTE are also provided.

In the eNB illustrated in FIG. 10, information bits addressed to a pair of UEs are input to the encoding units 204 and 205. Each of the encoding units performs channel encoding on the information bits and outputs encoded bits to the modulating unit 203. The modulating unit 203 performs modulation so that a signal obtained by combining the encoded bits of the respective UEs is mapped on a constellation, and outputs a modulated signal to the precoding unit 202.

The precoding unit 202 performs precoding on the modulated signal using W calculated by the above-described method and outputs a resulting signal to the transmitting unit 201. The transmitting unit 201 generates a radio signal from the precoded modulated signal and transmits the radio signal.

The precoding matrix W calculating unit 206 acquires the precoding matrix from the PMI received from each of a pair of UEs, calculates β related to a pair of UEs by the above-described method using the precoding matrix, and calculate W using β. The receiving unit 207 includes a function of receiving various kinds of uplink signals from the UE and acquiring information of the higher layer from received signals of the physical layer. Further, when transmitting the parameters such as W, β, and PMI to the UE, transmission is performed through the process at the transmission side using the parameters as information bits.

The entire configuration of the eNB illustrated in FIG. 10 may be implemented by a hardware circuit (for example, one or more IC chips), and a part of the configuration of the eNB may be implemented by a hardware circuit, and the remaining parts thereof may be implemented by a CPU and a program.

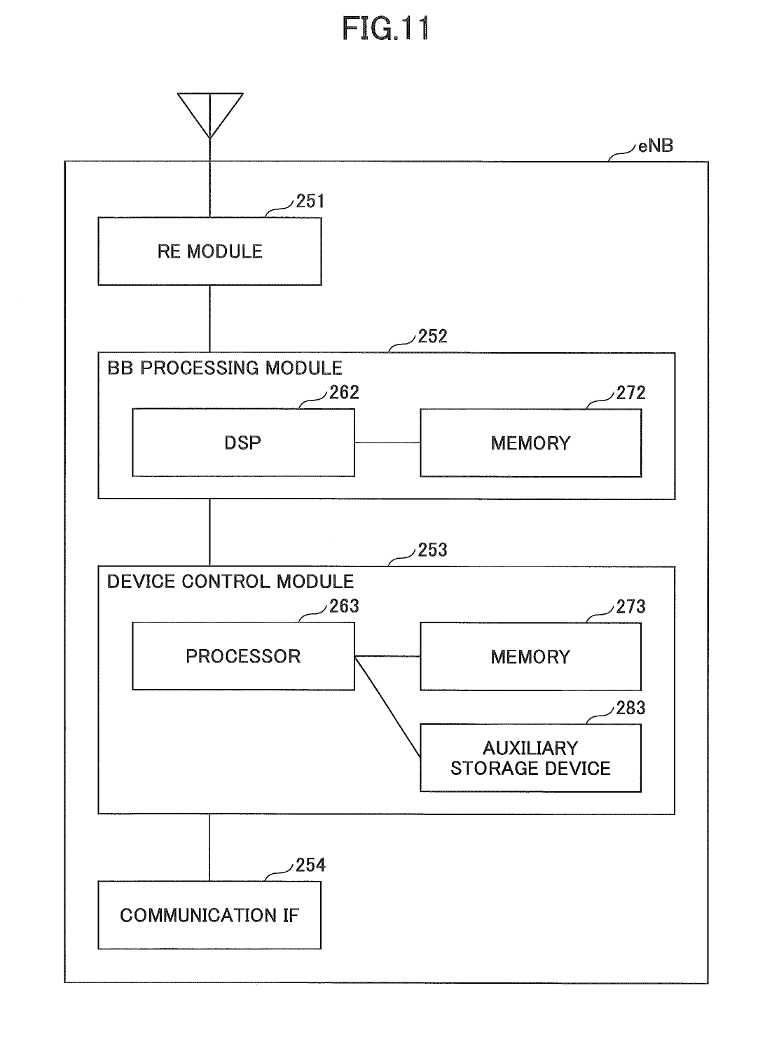

FIG. 11 is a diagram illustrating an example of a hardware (HW) configuration of the eNB. FIG. 11 illustrates a configuration that closer to an implementation example than FIG. 10. As illustrated in FIG. 11, the eNB includes an RE module 251 that performs processing relating to radio signals, a BB processing module 252 that performs baseband signal processing, a device control module 253 that performs processing of the higher layer, or the like, and a communication IF 254 serving as an interface for a connection with a network.

The RE module 251 performs D/A conversion, modulation, frequency transform, power amplification, and the like on digital baseband signals received from the BB processing module 252 and generates radio signals to be transmitted from an antenna. Further, the RE module 251 performs frequency transform, A/D conversion, demodulation, and the like on radio signals received from the antenna, generates digital baseband signals, and transfers the digital baseband signals to the BB processing module 252. For example, the RE module 251 includes functions of the physical layer or the like in the transmitting unit 201 and the receiving unit 207 of FIG. 10.

The BB processing module 252 performs a process of converting an IP packet into a digital baseband signal and vice versa. A DSP 262 is a processor that performs signal processing in the BB processing module 252. A memory 272 is used as a work area of the DSP 252. The BB processing module 252 includes, for example, functions of the layer 2 in the transmitting unit 201 and the receiving unit 207, the precoding unit 202, the modulating unit 203, the encoding units 204 and 205, and the precoding matrix W calculating unit 206 in FIG. 10. All or some of the functions of the precoding unit 202, the modulating unit 203, the encoding units 204 and 205, and the precoding matrix W calculating unit 206 may be included in the device control module 253.

The device control module 253 performs protocol processing of the IP layer, OAM processing, and the like. A processor 263 is a processor that performs processing performed by the device control module 253. A memory 273 is used as a work area of the processor 263. An auxiliary storage device 283 is, for example, an HDD or the like, and stores various kinds of configuration information and the like used for an operation of the base station eNB.

The configurations (functional classifications) of the devices illustrated in FIGS. 8 to 11 are merely examples of the configuration for implementing the process described in the present embodiment. An implementation method (a specific arrangement, names, and the like of the functional units) is not limited to a specific implementation method as long as the process described in the present embodiment can be performed.

### Summary of Embodiment

As described above, according to the present embodiment, provided is a base station used in a radio communication system, including: a precoding matrix calculating unit that calculates a precoding matrix based on a first precoding matrix reported from a first user equipment in a pair selected as a target of multiplexing in a power region and a second precoding matrix reported from a second user equipment in the pair; and a precoding unit that applies a precoding to transmission signals to the first user equipment and the second user equipment using the precoding matrix calculated by the precoding matrix calculating unit.

Through the above configuration, it is possible to increase a possibility that each user equipment will be a pairing target without increasing the feedback amount from the user equipment in the technique in which multiplexing in a power region is performed.

The precoding matrix calculating unit may calculate the precoding matrix by weighting and adding the first precoding matrix and the second precoding matrix. Through this configuration, throughput of the user equipment can be improved.

The precoding matrix calculating unit may calculate a precoding matrix using a plurality of weight candidates and decide a weight for calculating the precoding matrix used in the precoding unit from the plurality of weight candidates according to reception qualities of the first user equipment and the second user equipment estimated based on the calculated precoding matrix. Through this configuration, an optimum weight can be decided.

The base station may further include a transmitting unit that transmits the precoding matrix used in the precoding unit or an index of the precoding matrix to the first user equipment or the second user equipment. Through this configuration, in the case of the closed loop control or the like, the user equipment can appropriately perform feedback estimation or the like.

Further, the base station may further include a transmitting unit that transmits the weight used for the calculation of the precoding matrix used in the precoding unit and an index of the first precoding matrix to the second user equipment, and transmits the weight and an index of the second precoding matrix to the first user equipment. Through this configuration, in the case of the closed loop control or the like, the user equipment can appropriately perform feedback estimation or the like.

Further, according to the present embodiment, provided is a user equipment used in a radio communication system, including: a transmitting unit that transmits an index of a first precoding matrix to a base station; and a receiving unit that receives a precoding matrix calculated in the base station or an index of the precoding matrix from the base station, wherein the user equipment is a first user equipment in a pair selected as a target of multiplexing in a power region by the base station, and the precoding matrix is a precoding matrix calculated by the base station based on the first precoding matrix and a second precoding matrix of a second user equipment in the pair.

Through the above configuration, it is possible to increase a possibility that each user equipment will be a pairing target without increasing the feedback amount from the user equipment in the technique in which multiplexing in a power region is performed.

Further, according to the present embodiment, provided is a user equipment that is used in a radio communication system and serves as a first user equipment in a pair selected as a target of multiplexing in a power region by a base station, including: a transmitting unit that transmits an index of a first precoding matrix to the base station; a receiving unit that receives a second precoding matrix of a second user equipment in the pair from the base station; and a precoding matrix calculating unit that calculates a precoding matrix to be applied to the user equipment in the base station based on the first precoding matrix and the second precoding matrix.

Through the above configuration, it is possible to increase a possibility that each user equipment will be a pairing target without increasing the feedback amount from the user equipment in the technique in which multiplexing in a power region is performed.

The exemplary embodiments of the present invention have been described above, but the disclosed invention is not limited to the above embodiments, and those skilled in the art would understand that various modified examples, revised examples, alternative examples, substitution examples, and the like can be made. In order to facilitate understanding of the invention, specific numerical value examples have been used for description, but the numerical values are merely examples, and certain suitable values may be used unless otherwise stated. The classification of items in the above description is not essential to the present invention. matters described in two or more items may be combined and used as necessary, and a matter described in one item may be applied to a matter described in another item (unless inconsistent). The boundary between functional units or processing units in a functional block diagram does not necessarily correspond to the boundary between physical parts. Operations of a plurality of functional units may be performed physically by one component, or an operation of one functional unit may be performed physically by a plurality of parts. For the sake of convenience of description, the base station eNB and the user equipment UE have been described using the functional block diagrams, but such devices may be implemented by hardware, software, or a combination thereof. Software executed by the processor included in the user equipment UE according to the embodiment of the present invention and software executed by the processor included in the base station e NB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

### Supplement of Embodiment

The transmission of information is not limited to the aspects/embodiments described in the specification and may be performed by other means. For example, the transmission of information may be performed by physical layer signaling (for example, downlink control information (DCI) or uplink control information (UCI)), higher layer signaling (for example, radio resource control (RRC) signaling, medium access control (MAC) signaling, or broadcast information (a master information block (MIB) and a system information block (SIB))), another signal, or a combination thereof. The RRC signaling may be also referred to as an RRC message and may be, for example, an RRC connection setup message or an RRC connection reconfiguration message.

Each aspect/embodiment described in the specification may be applied to systems using Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other suitable systems and/or next-generation systems that have functionality enhanced based on these systems.

Decision or determination may be made based on a value (0 or 1) represented by 1 bit, may be made based on a true or false value (boolean: true or false), or may be made based on comparison with a numerical value (for example, comparison with a predetermined value).

The terms described in the specification and/or terms necessary to understand the specification may be replaced with terms that have same or similar meanings. For example, a channel and/or a symbol may be a signal. A signal may be a message.

The UE may be referred to, by those skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

The aspects/embodiments described in the specification may be individually used, may be combined, or may be switched during execution. In addition, transmission of predetermined information (for example, transmission of “being X”) is not limited to being performed explicitly, but may be performed implicitly (for example, the transmission of the predetermined information is not performed).

The terms “determining” and “deciding” used in the specification include various operations. The terms “determining” and “deciding” can include, for example, “determination” and “decision” for calculating, computing, processing, deriving, investigating, looking-up (for example, looking-up in a table, a database, or another data structure), and ascertaining operations. In addition, the terms “determining” and “deciding” can include “determination” and “decision” for receiving (for example, information reception), transmitting (for example, information transmission), input, output, and accessing (for example, accessing data in a memory) operations. The terms “determining” and “deciding” can include “determination” and “decision” for resolving, selecting, choosing, establishing, and comparing operations. That is, the terms “determining” and “deciding” can include “determination” and “decision” for any operation.

The term “based on” used in the specification does not mean “only based on” unless otherwise stated. In other words, the term “based on” means both “only based on” and “at least based on”.

In the processes, sequences, and flowcharts, etc., in each aspect/embodiment described in the present specification, the order of processes may be exchanged, as long as there is no inconsistency. For example, for the methods described in the present specification, elements of the various steps are presented in an exemplary order and are not limited to the presented specific order.

The input/output information, etc., may be stored in a specific location (e.g., a memory), or may be managed by a management table. The input/output information, etc., may be overwritten, updated, or added. The output information, etc., may be deleted. The input information, etc. may be transmitted to another device.

Reporting of predetermined information (e.g., reporting of “being X”) is not limited to explicit reporting, but also it may be implicitly performed (e.g., not performing reporting of the predetermined information).

The information, the signal, and the like described in the specification may be represented using any of various technologies. For example, the data, the instruction, the command, the information, the signal, the bit, the symbol, the chip, and the like mentioned throughout the description may be represented by a voltage, a current, an electromagnetic wave, a magnetic field, or a magnetic particle, an optical field or a photon, or any combination thereof.

The present invention is not limited to the above embodiments, and various modifications, modifications, alternatives, substitutions, and the like are included in the present invention without departing from the spirit of the present invention.

This patent application is based upon and claims the benefit of priority of Japanese Patent Application No. 2016-020330 filed on Feb. 4, 2016 and the entire contents of Japanese Patent Application No. 2016-020330 are incorporated herein by reference.

### EXPLANATIONS OF LETTERS OR NUMERALS

UE user equipment
eNB base station
101 receiving unit
102 precoding matrix W acquiring unit
103 feedback information generating unit
104 transmitting unit
111 replica generating unit
121 interference cancelling unit
131 desired signal acquiring unit
152 BB processing module
153 device control module
154 USIM slot
201 transmitting unit
202 precoding unit
203 modulating unit
204, 205 encoding unit
206 precoding matrix W calculating unit
207 receiving unit
251 RE module
252 BB processing module
253 device control module
254 communication IF

1. A base station used in a radio communication system, comprising:
a precoding matrix calculating unit that calculates a precoding matrix based on a first precoding matrix reported from a first user equipment in a pair selected as a target of multiplexing in a power region and a second precoding matrix reported from a second user equipment in the pair; and
a precoding unit that applies a precoding to transmission signals to the first user equipment and the second user equipment using the precoding matrix calculated by the precoding matrix calculating unit.

2. The base station according to claim 1, wherein the precoding matrix calculating unit calculates the precoding matrix by weighting and adding the first precoding matrix and the second precoding matrix.

3. The base station according to claim 2, wherein the precoding matrix calculating unit calculates a precoding matrix using a plurality of weight candidates, and decides a weight for calculating the precoding matrix used in the precoding unit from the plurality of weight candidates according to reception qualities of the first user equipment and the second user equipment estimated based on the calculated precoding matrix.

4. The base station according to claim 1, further comprising, a transmitting unit that transmits the precoding matrix used in the precoding unit or an index of the precoding matrix to the first user equipment or the second user equipment.

5. The base station according to claim 2, further comprising, a transmitting unit that transmits the weight used for the calculation of the precoding matrix used in the precoding unit and an index of the first precoding matrix to the second user equipment, and transmits the weight and an index of the second precoding matrix to the first user equipment.

6. A user equipment used in a radio communication system, comprising:
a transmitting unit that transmits an index of a first precoding matrix to a base station; and
a receiving unit that receives a precoding matrix calculated in the base station or an index of the precoding matrix from the base station,
wherein the user equipment is a first user equipment in a pair selected as a target of multiplexing in a power region by the base station, and
the precoding matrix is a precoding matrix calculated by the base station based on the first precoding matrix and a second precoding matrix of a second user equipment in the pair.

7. A user equipment that is used in a radio communication system and serves as a first user equipment in a pair selected as a target of multiplexing in a power region by a base station, comprising:
a transmitting unit that transmits an index of a first precoding matrix to the base station;
a receiving unit that receives a second precoding matrix of a second user equipment in the pair from the base station; and
a precoding matrix calculating unit that calculates a precoding matrix to be applied to the user equipment in the base station based on the first precoding matrix and the second precoding matrix.

8. (canceled)

9. (canceled)

10. (canceled)

11. The base station according to claim 2, further comprising, a transmitting unit that transmits the precoding matrix used in the precoding unit or an index of the precoding matrix to the first user equipment or the second user equipment.

12. The base station according to claim 3, further comprising, a transmitting unit that transmits the precoding matrix used in the precoding unit or an index of the precoding matrix to the first user equipment or the second user equipment.
